(19) United States
(12) Patent Application Publication
(10) Pub. No.: US 2015/0026111 A1
(43) Pub. Date: Jan. 22, 2015

(54) METHOD FOR ENGAGING ISOLATED INDIVIDUALS

(71) Applicant: GREATCALL, INC., San Diego, CA (US)

(72) Inventors: Kotaro Matsuo, San Diego, CA (US); Dean Williams, San Diego, CA (US); Krijn van der Raadt, San Diego, CA (US); David Inns, San Diego, CA (US); Madeline Pantalone, San Diego, CA (US)

(73) Assignee: GREATCALL, INC., San Diego, CA (US)

(21) Appl. No.: 13/947,940

(22) Filed: Jul. 22, 2013

(51) Int. Cl. G06N 5/02

(52) U.S. Cl. CPC G06N 5/022
USPC 706/46

(57) ABSTRACT

Methods and systems for engaging isolated individuals. In an example implementation, a variety of historical information about a client is received, indicating that certain prior events have occurred in the life of the client. The historical information is stored in electronic storage, and one or more patterns are detected, using a specially programmed computer system, that relate the prior events occurring to the client to presumed indicators of the client's mood. A description of the one or more detected patterns is recorded in the electronic storage. In some implementations, it may be automatically recognized, based on the one or more detected patterns that one or more additional events presumed to indicate the possible onset of a negative mood on the part of the client have occurred, and one or more measures presumed to mitigate the negative mood on the part of the client may be applied.

### BACKGROUND OF THE INVENTION

Studies show that increasing numbers of Americans live alone. The trend toward living alone affects Americans of all ages, but may be especially pronounced among the elderly. According to statistics from the U.S. Department of Health and Human Services Administration on Aging, about 11.3 million Americans over the age of 65 lived alone in 2011.

While some persons may thrive in a solo environment, others may feel isolated and out of touch with friends and family. Isolation may also include people who are “substantially alone”, for example people who live alone but have family caregivers and/or professional caregivers remotely located, or who may live with limited (not daily) in-person interaction. Some sociologists suggest that isolation may also be associated with adverse health effects for some people.

### BRIEF SUMMARY OF THE INVENTION

According to one aspect, a method includes receiving a variety of historical information about a client of a call center, the historical information indicating that certain prior events have occurred in the life of the client, and storing the historical information in electronic storage. The method further includes detecting, using a computer system specially programmed to do so, one or more patterns that relate the prior events occurring to the client to presumed indicators of the client's mood, and recording in the electronic storage a description of the one or more detected patterns. In some embodiments, the method further includes receiving additional information about the client, indicating that one or more additional events have occurred in the life of the client; automatically recognizing, by the computer system, based on the one or more detected patterns, that one or more additional events presumed to indicate the possible onset of a negative mood on the part of the client have occurred; and applying one or more measures presumed to mitigate the negative mood on the part of the client. In some embodiments, the historical information and the additional information include measurements of one or more biological factors of the client, and a particular measurement or set of measurements of one or more of the one or more biological factors constitutes an event. In some embodiments, the measurements of one or more biological factors of the client include measurements of any one, any combination, or all of the factors in the group consisting of a body temperature of the client, a blood pressure of the client, a weight of the client, a heart rate of the client, and an activity level of the client. In some embodiments, measurements of at least one of the one or more biological factors of the client are made automatically and are received at the call center after transmission over a wireless link. At least one biological factor may be measured using a device worn by the client. Measurements of one or more biological factors of the client may include one or more measurements self-reported by the client. In some embodiments, the historical information and the additional information include measurements of one or more environmental factors, and a particular measurement or set of measurements of one or more of the one or more environmental factors constitutes an event. In some embodiments, the measurements of one or more environmental factors include measurements of any one, any combination, or all of the environmental factors selected from the group consisting of the client's location, the environmental temperature at the client's location, the barometric pressure at the client's location, the pollen count at the client's location, the humidity at the client's location, the air quality at the client's location, and the weather at the client's location. In some embodiments, at least one of the one or more environmental factors are made automatically and are received at the call center after transmission over a wireless link. At least one event may be self-reported by the client. In some embodiments, the prior and additional events comprise any one, any combination, or all of the events selected from the group of a news report of a current event, a report of a particular weather pattern, and emergency alert issued by an official agency, and a forecast of a particular weather pattern. At least one mood may be self-reported by the client. In some embodiments, the one or more measures presumed to mitigate the negative mood on the part of the client include any one, any combination, or all of the measures selected from the group consisting of sending one or more electronic messages to the client intended to mitigate the negative mood, notifying a person previously designated by the client, and altering the client's environment. In some embodiments, the method further includes storing the additional information in the electronic storage, such that the additional information is historical information in a future analysis. In some embodiments, the client is a first client and the method further includes receiving a variety of historical information about a plurality of other clients of the call center, the historical information indicating that certain prior events have occurred in the lives of the other clients; storing the historical information about the plurality of other clients in electronic storage; and detecting, using the computer system, one or more patterns that relate the prior events occurring to the other clients to presumed indicators of the other clients' moods; wherein automatically recognizing that the one or more additional events presumed to indicate the possible onset of a negative mood on the part of the first client have occurred is based at least in part on the patterns detected with respect to the other clients.

According to another aspect, a system includes a processor, electronic storage, and a memory. The memory holds instructions that when executed by the processor cause the system to receive a variety of historical information about a person, the historical information indicating that certain prior events have occurred in the life of the person, and store the historical information in the electronic storage. The instructions further cause the system to detect one or more patterns that relate the prior events occurring to the client to presumed indicators of the person's mental or physical well-being, and record in the electronic storage a description of the one or more detected patterns. In some embodiments, the instructions when executed by the processor further cause the system to receive additional information about the person, indicating that one or more additional events have occurred in the life of the person; automatically recognize, based on the one or more detected patterns, that one or more additional events presumed to affect the person's mental or physical well-being have occurred; and apply one or more measures presumed to mitigate the effects of the one or more additional events on the client's mental or physical well-being. In some embodiments, the system further includes an electronic communication interface, and at least one of the one or more measures presumed to mitigate the effects of the one or more additional events on the client's mental or physical well-being is applied through the electronic communication interface.

According to another aspect, a system for engaging individuals includes a prediction engine that receives information about a plurality of individuals and detects patterns relating events occurring in the lives of the individuals with presumed indicators of the individuals' mental or physical well-being. The prediction engine uses the recognized patterns and additional received information to predict an impending change to a particular individual's mental or physical well-being. The system further includes an intervention engine that, in response to the prediction of the impending change, applies one or more measures presumed to positively affect the particular individual's mental or physical well-being. In some embodiments, the prediction engine identifies at least some events from the received information. In some embodiments, at least one measure presumed to positively affect the particular individual's mental or physical well-being is applied using human assistance. In some embodiments, the received information includes measurements of one or more biological factors of the client, and a particular measurement or set of measurements of one or more of the one or more biological factors constitutes an event. In some embodiments, the one or more measures presumed to positively affect the particular individual's mental or physical well-being include any one, any combination, or all of the measures selected from the group consisting of sending one or more electronic messages to the client intended to mitigate the negative mood, notifying a person previously designated by the client, and altering the client's environment. In some embodiments, the prediction engine detects patterns relating events occurring in the lives of the individuals based in part on keywords associated with at least some of the events.

### BRIEF DESCRIPTION OF THE DRAWINGS

FIG. 1 illustrates a system including a private response center (PRC), in which embodiments may be practiced.

FIG. 2 illustrates an example client profile, according to embodiments of the invention.

FIG. 3 illustrates a simplified communications device, in accordance with embodiments.

FIG. 4 illustrates a flowchart of a method in accordance with embodiments.

FIG. 5 illustrates a simplified block diagram of an example embodiment of the internal structure of a computer system.

FIG. 6 illustrates a schematic view of the operation of a system in accordance with embodiments.

### DETAILED DESCRIPTION OF THE INVENTION

The ensuing description provides preferred example embodiment(s) only, and is not intended to limit the scope, applicability or configuration of the disclosure. Rather, the ensuing description of the preferred example embodiment(s) will provide those skilled in the art with an enabling description for implementing a preferred example embodiment. It is understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, systems, structures, and other components may be shown as components in block diagram form in order not to obscure the embodiments in unnecessary detail. In other instances, well-known processes, procedures and techniques may be shown without unnecessary detail in order to avoid obscuring the embodiments.

Also, it is noted that individual embodiments may be described as a process which is depicted as a flowchart, a flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed, but could have additional steps not included in a figure. Furthermore, embodiments may be implemented by manual techniques, automatic techniques, or any combination thereof.

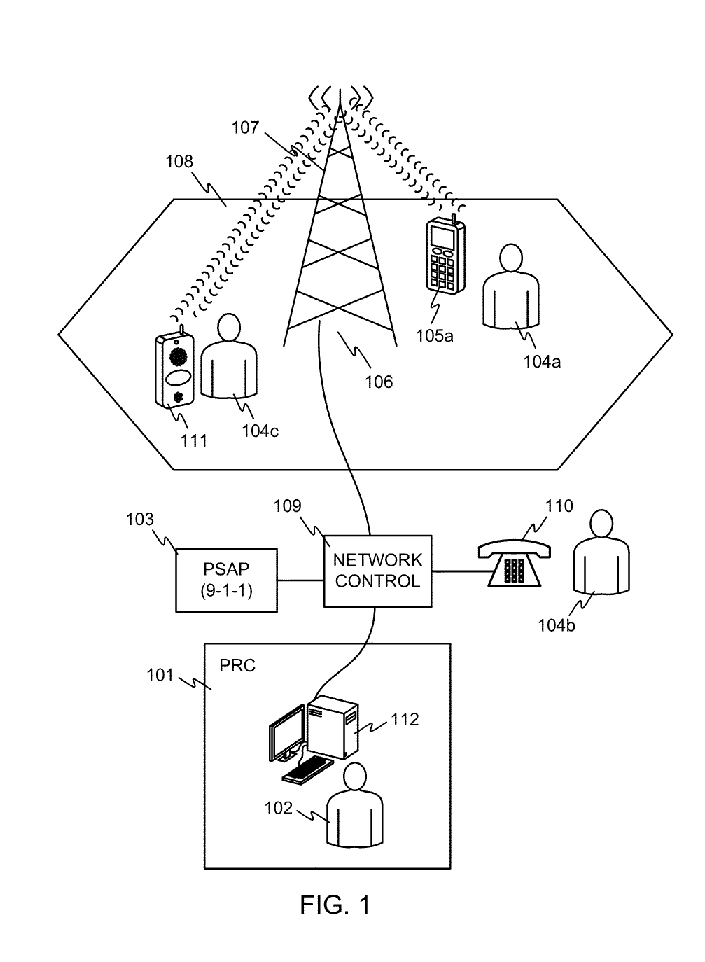

FIG. 1 illustrates a system including a private response center (PRC) 101, in which embodiments may be practiced Private response center 101 may be operated, for example, by a provider who offers personalized assistance service to clients subscribing to the service. In some embodiments, the service provider may offer personal health management advice, concierge services, navigational assistance, technical support for telephones used in conjunction with the service, or other kinds of personalized services deliverable by telephone. Private response center 101 may be staffed by customer service representatives 102 who answer inquiries from clients of the service. Such a service may especially appeal to clients with health or other impairments. For example, the service could include weekly or daily calls to the client for verification that the client is doing well, and if not, the customer service representative may offer to contact a family member, health care provider, or other resource that may be helpful to the client. The service could include these and other services sold as a package. Alternatively, PRC 101 may be a fully automated service designed to operate without human intervention.

Private response center 101 is not intended to be a substitute for a public safety answering point (PSAP) 103. A U.S. client of the service offered by private response center 101 would still be expected to dial 9-1-1 to reach PSAP 103 in the event of an emergency.

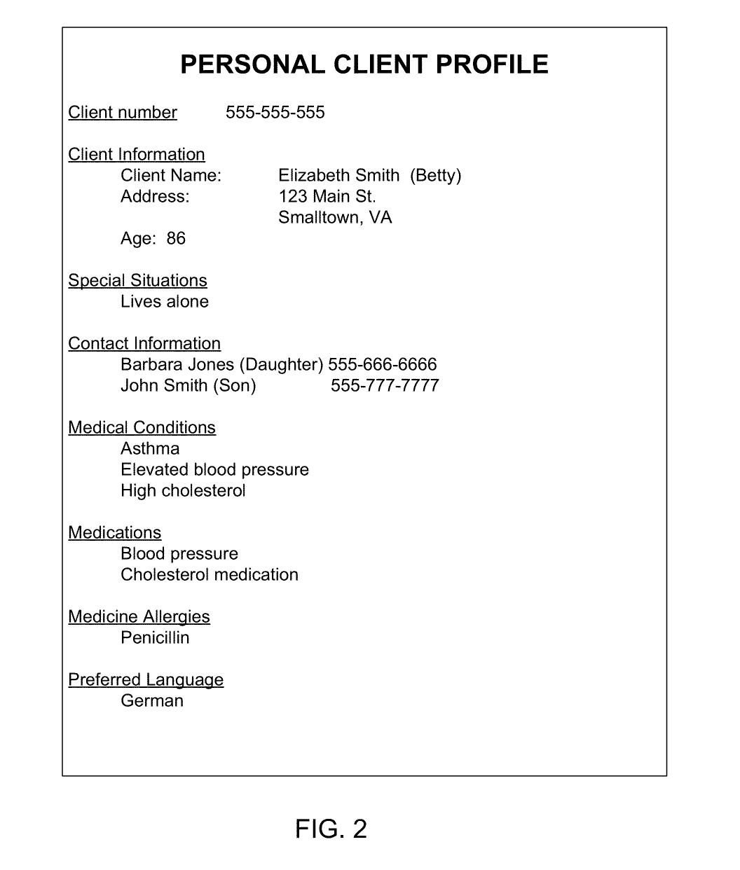

PRC 101 includes a computer system 112 that may be used for various functions. For example, information about calls from clients may be displayed to customer service representative 202. Computer system 112 may store personal information gathered from clients that may be helpful in rendering assistance to the clients. For example, computer system 112 may store a profile of each client, listing information such as designated persons to contact in the event that the client is in need of assistance that could be supplied by a friend or family member, medications the client is taking, medical conditions the client may have, allergies to medicines, and other kinds of information. FIG. 2 illustrates an example client profile. When a client calls PRC 101, the client may be automatically identified by his or her telephone number, and computer system 112 may retrieve the client's profile for viewing by the customer service representative handling the call.

More information about services that may be performed by PRC 101 can be found in U.S. patent application Ser. No. 12/981,822 filed Dec. 30, 2010 and titled “Extended Emergency Notification Systems and Methods”, U.S. patent application Ser. No. 13/004,481 filed Jan. 11, 2011 and titled “Emergency Call Redirection Systems and Methods”, U.S. patent application Ser. No. 13/004,612 filed Jan. 11, 2011 and titled “Emergency Call Return Systems and Methods”, and U.S. patent application Ser. No. 13/026,158 filed Feb. 11, 2011 and titled “Systems and Methods for Identifying Caller Locations”, the entire disclosures of which are hereby incorporated herein by reference for all purposes.

Computer system 112 may assist customer service representative 102 in the performance of his or her job in other ways as well, for example automating telephone dialing and the like. While computer system 112 is illustrated as a single computer, it will be recognized that the term “computer system” encompasses many different kind of installations, including systems of multiple computers linked together. The multiple computers may be co-located or widely dispersed.

Clients of PRC 101, exemplified by clients 104a-104c, may preferably reach of PRC 101 by telephone. In the example system of FIG. 1, client 104a uses a conventional full featured cellular telephone 105a, having buttons, a touchscreen, or another kind of user interface the permits telephone numbers to be entered to initiate calls. Cellular telephone 105a may also be a “smartphone”, with the ability to run application programs, connect to the Internet, and perform other functions. Cellular telephone 105a communicates wirelessly with a cellular base station 106, which has an associated tower 107. For simplicity of explanation, only one cell 108 of a larger cellular network is shown. In practice, the cellular network may have thousands of cells.

Base station 106 is connected to a network controller 109. It will be understood that network controller 109 is shown as highly simplified in FIG. 1, and represents a wide array of hardware, software, and other components performing a wide variety of functions. For example, network controller 109 may route calls between cells 108 and outside telephone providers, monitor telephone usage, maintain billing records for individual telephone accounts, perform diagnostic tests, and perform many other functions.

Other clients may reach PRC 101 using other kinds of devices. For example, client 104b communicates with PRC 101 using a conventional landline telephone 110. In another example, client 104c reaches PRC 101 using a simplified communications device 111.

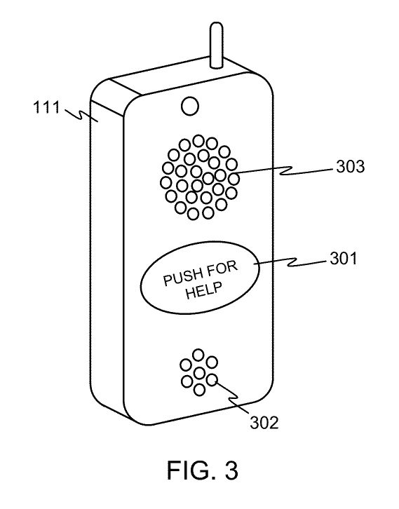

FIG. 3 illustrates simplified communications device 111 in more detail, in accordance with embodiments. Example communications device 111 may internally be a fully-featured cellular telephone, but has a simplified input interface comprising only one button 301. Communications device 111 may also be referred to as a “personal security device” or an “emergency communicator.” A client of private response center 101 may wear communications device 111 on his or her person, and can use it to contact private response center 101 whenever assistance is needed. For example, communications device 111 may be configured to dial private response center 101 when button 301 is pressed. This greatly simplified input interface may be especially helpful to clients with impairments such as poor vision or coordination that make it difficult to operate a conventional cellular telephone that has many small keys. The single-button interface assures that private response center 301 will be called without the client having to press a sequence of keys. In the event of an emergency, private response center 101 may route the call to the proper authorities, if necessary. Communications device 111 further includes a microphone 302 and a speaker 303, enabling telephone or telephone-like communication.

In some embodiments, PRC 101 may track the location of the cellular telephone, simplified communications device, or other portable device used by a particular client to contact PRC 101. For example, simplified communications device 111 may include a global positioning system (GPS) receiver, and may periodically determine its location and report the location to PRC 101. Other kinds of position location may be used as well, for example simplified communications device 111 may periodically request a reading of its location from the cellular telephone network, which maintains records of the locations of active cellular telephones as part of its normal operation. Location methods may also be used in combination, for example as described in U.S. patent application Ser. No. 13/026,158 previously incorporated by reference.

In one example scenario, the service provider that operates PRC 101 may also be a cellular telephone service provider, and may offer a private assistance service as an adjunct to cellular telephone service. PRC 101 can be contacted for non-emergency service through a phone number, speed dial or other shortcut, for example by activating a 5 and * key combination. A client using a smartphone may load an application onto his or her phone, and use the application to contact PRC 101.

According to embodiments of the invention, PRC 101 receives and stores information about a client of PRC 101, and uses the stored information to engage the client in ways intended to promote the client's mental or physical well-being. For the purposes of this disclosure, the phrase “mental or physical well-being” or the like encompasses mental well-being alone, physical well-being alone, and both mental and physical well-being together.

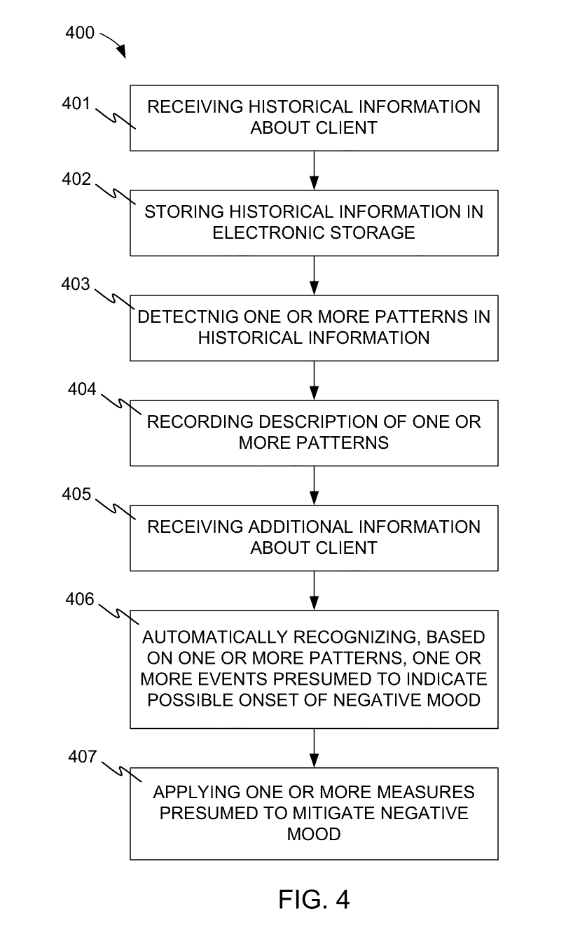

FIG. 4 illustrates a flowchart of a method 400 in accordance with embodiments. Method 400 may be performed, for example, at least partially by a specially programmed computer such as computer system 112. In step 401, historical information is received about the client. The historical information indicates that certain historical events have occurred in the life of the client. In step 402, the historical information is stored in electronic storage.

The historical information may be gathered in any number of automatic or human-assisted ways. For example, a client's telephone 105a or simplified communications device 111 may periodically determine and report its geographical location to PRC 101. These periodic reports may be collected and stored, and indicate certain historical events. For example, in some cases the majority of the location reports may show that the client is at home, but other reported locations may correspond to and indicate visits to other geographic locations such as the home of a relative, a restaurant, a church, an activity center, a well-known vacation destination, or another identifiable location. These visits away from home may be examples of events in the life of the client, and may be automatically recognized by computer system 112.

Other kinds of historical information may be gathered automatically as well. For example, a client may wear a health monitoring device that includes an accelerometer and reports periods of exercise based on the accelerometer readings. These periods may be considered as historical events in the life of the client. The episodes may be categorized by intensity level based on the magnitude of the accelerometer readings, and may be categorized by exercise type (walking, aerobics, etc.) based on the magnitude and pattern of the accelerometer readings.

The historical information may include biological factors of the client, for example, the client's heart rate, body temperature, blood sugar level, blood pressure, or other biological factors of combinations of factors. At least some of the biological factors may be measured and reported automatically. For example, a wearable device could measure the client's heart rate, blood sugar level, or other factors. An electronic scale may report the client's weight to the client's telephone or other communicator, for example via a Bluetooth, WiFi, Zigbee, WWAN, NFC, or other wireless connection, for forwarding to PRC 101.

Other kinds of information may be gathered with the assistance of customer service representatives 102 or other persons. For example, as part of the service offered by PRC 101, each client may receive periodic check-in calls, in which a customer service representative asks the client if he or she is doing well, and engages the client in conversation. After a check-in call, the customer service representative may enter information into a computerized database. For example, if the client reported having been to a favorite restaurant or to visit family, information would be entered indicating those events in the life of the client. Preferably, the information is entered using key words or selections from a menu so that the resulting stored data is easily searchable and is amenable to computer analysis, as is described in more detail below.

In some embodiments, check-in calls may be automated, and conducted by a interactive voice response (IVR) system. In this kind of system, the IVR system may ask the client questions and ask for voice responses or that responses be keyed in using the keypad on the client's telephone. Voice responses may be especially helpful for a particular client who uses a simplified communications device 111. For automated systems, the information captured during the interaction may be automatically entered into an computerized database.

In other embodiments, historical information may be self-reported by the client. For example, clients of PRC 101 may be encouraged to log into a web site periodically and report recent biological factor readings such as blood pressure readings, blood sugar readings, weights, and other information. The client may also be encouraged to report other events such as visits to family, visits to the doctor, how much the client has exercised recently, and the like.

In some embodiments, events may be recorded directly. Examples of events that may be directly recorded, in addition to events self-reported by the client, include news reports of current events, weather reports or forecasts, official emergency alerts such as severe weather warnings, and the like. Events may also include pre-arranged meetings with people, conferences, or similar items accessed from calendar or schedule information. Whether or not the client attended the meeting can be induced from location information correlated with the time and day of the meeting. “Chance” meetings with known people may also be derived from, for example, knowing that known contacts are in proximity via GPS, NFC, social networks or similar methods. Proximity of certain landmarks that may contribute to a positive mood, such as doctor's offices, music stores, fast food restaurants, public parks, or shopping malls may also be recorded. In addition, proximity of certain landmarks that may contribute to a negative mood, such as an ex-spouse's apartment or a county jail may also be recorded. A client's mood may encompass the client's general mental state, how the client is feeling, or what the client senses.

Information from all of these sources may be stored in electronic storage for analysis.

Another kind of historical information received and stored may be measurements of one or more environmental factors. For example, in some embodiments, the client's geographical location may be considered to be an environmental factor. Other environmental factors may include the environmental temperature, barometric pressure, relative humidity, pollen count, air quality, or weather conditions at the client's location. As with other kinds of information, environmental information may be gathered and transmitted automatically to PRC 101, may be self-reported by the client, or may be obtained in another way. For example, information about weather, air quality, pollen count, and the like may be obtained from online information sources and correlated with the client's location.

Referring again to FIG. 4, in step 402 the historical information is stored in electronic storage. The electronic storage is preferably readily accessible, and may be solid state non-volatile or volatile memory, magnetic storage such as one or more magnetic disks or tapes, optical storage such as one or more optical disks drives, or any other suitable kind of storage or combination of storage types.

In step 403, the historical information is analyzed and patterns are recognized within the historical information. The analysis is performed using a computer system, for example computer system 112, specially programmed to do so. The recognized patterns relate prior events recorded in or derived from the stored historical information with presumed indicators of the client's mood. For example, the historical information may indicate that a particular often client self-reports a good mood after visits to family members, or after periods of moderately high physical activity. Conversely, another client may often self-report sadness or exhibit other signs of a negative mood after visits to family. In another example, biological factors of a particular client, for example blood pressure readings, may suggest that the client feels emotional stress after reports of natural disasters have been in the news, or during extended periods of cloudy weather. In another example, regular physical activity indicative of regular exercise may be presumed to be an indicator of a positive mood on the part of a client, while an apparent lack of physical activity may be presumed to indicate a negative mood. Of course, many, many, other patterns are possible. Any suitable pattern recognition algorithm may be used to recognize the patterns, for example discriminant analysis, cluster analysis, or other algorithms or combinations of algorithms. It will be recognized that for an entity such as PRC 101 having a number of clients, such pattern recognition would be impracticable without computerized assistance.

The correlations between events and a client's mood are presumed, and some correlations may be stronger or more accurate than others. For the purposes of this disclosure, it is not necessary that a presumed relationship between an indicator and a client's mood be supported by scientific evidence, although PRC 101 may endeavor to use indicators that are as accurate as possible, and may refine its understandings of mood indicators over time. For example, PRC 101 may add or remove measurements of a certain biological or other factor from the gathered information if it is determined that including that particular factor in the analysis does not improve prediction of a client's mood. Similarly, PRC 101 may gather new kinds of information if it appears a new variable could improve the prediction of clients' moods.

In step 404, a description of the recognized patterns is stored in the electronic storage.

In some embodiments, the stored pattern descriptions are used in conjunction with additional event information to recognize that ongoing events may signal the onset of a negative mood on the part of the client. For example, information similar to the historical information on which the pattern descriptions are based may be collected on an ongoing basis. This information may be referred to as “additional” information, to distinguish it from the “historical” information on which the pattern descriptions are based. However, the additional information may also be stored in the electronic storage and may become available for future pattern recognition analyses. Thus the pattern descriptions may be updated on an ongoing basis, with the “additional” information used for prediction becoming “historical” information for ongoing pattern recognitions.

Referring again to FIG. 4, step 405 depicts receiving the additional information, indicating the occurrence of additional events in the life of the client. For example, once a set of pattern descriptions has been stored, the system may receive geographic location information about a client indicating that the client is away from home visiting a particular location, or that a particular kind of weather is predicted for the client's area. As before, the “additional” events may be stored in the electronic storage and incorporated into later pattern detections, so that the “additional” events become “historical” events for the purpose of a future analysis.

In step 406, it is automatically recognized, based on the patterns previously detected, that the additional events have occurred that are presumed to indication the possible onset of a negative mood on the part of the client. For example, the location that a client is visiting may have previously been associated with high blood pressure readings and a self-reported negative mood on the part of the client. If it is presumed that high blood pressure readings and a self-reported negative mood are indicators of a negative mood, then it may be presumed that the new visit to that location may also portend a negative mood.

In step 407, one or more measures presumed to help mitigate the negative mood on the part of the client are applied. For example, upon recognizing that a negative mood may be indicated for a particular client, a customer service representative at PRC 101 may place an additional call to the client on the presumption that additional contact will be beneficial to the client. In another example, a family member of the client may be notified, on the presumption that the family member will take steps to contact the client, or otherwise provide help, support, or encouragement that may be helpful in mitigating a negative mood. In other cases, a person other than a family member may be contacted for a similar purpose. In some embodiments, the family member or other person may have been previously designated by the client as an emergency or other contact for issues involving the client. As is discussed above, for the purposes of this disclosure, the presumption that a particular measure will be helpful need not be supported by scientific evidence, but PRC 101 may endeavor to provide measures that are as helpful as possible, and may refine its techniques over time.

In some embodiments, measures presumed to mitigate the client's negative mood may be applied automatically. For example, an encouraging telephone message may be sent to the client's telephone or simplified communications device; an encouraging electronic mail message may be sent to the client's electronic mail account, smart phone, television, or other appliance; a greeting card may be automatically printed and sent to the client by postal mail; or other measures may be applied. In another example, flowers, gift certificates, movie tickets, coupons, or similar items may be sent or presented to the client. Computer system 112 may include one or more electronic communication interfaces for delivering messages and the like, for example a connection to the Internet for delivering electronic mail, a telephone capability for delivering recorded messages, or other kinds of electronic interfaces or combinations of electronic interfaces.

In some embodiments, materials and messages included in electronic mail or voice messages may be selected from a client-specific repository of materials provided by the client, the client's family, or others familiar with the client. For example, an encouraging electronic mail message may include a recent photo of the client's grandchildren provided by a child of the client, or a photo of a happy occasion in the client's life, on the presumption that receiving the photo will be helpful to the client. In some embodiments, encouraging messages may be automatically selected at random from the repository, and the repository may be updated periodically to maintain freshness of the materials. These messages may be automatically updated from a pre-existing repository, or an automatic message may be sent to a client's family to “refill” the repository of messages as some messages are “used up.” In other embodiments, encouraging messages may be categorized and selected based on the kind of event that prompted the need for an encouraging message. Many other techniques are possible for selecting messages.

In some embodiments, PRC 101 may provide family members or other designated persons information that may be helpful in their interactions with the client. For example, a notification message to a family member indicating that the client may be experiencing a difficult time may also include a link to a website with information about how to be helpful to the client. The website may include examples of encouraging words that may help a family member write a greeting card. Persons who are designated contacts for clients of PRC 101 may be encouraged to form an online community for discussing their roles and responsibilities, suggesting comforting or encouraging measures, and the like. PRC 101 may host such a community forum using a computer such as computer system 112. Members of the forum may offer support and suggestions to each other.

In some embodiments, the one or more measures presumed to mitigate the negative mood on the part of the client may include changing the client's environment. For example, PCR 101 may be authorized (possibly via an opt-in procedure or the like) to update the client's home computer, and may alter the home computer in ways that are presumed to be helpful. For example, the computer background screen or “screen saver” image may be changed periodically to display images thought to be encouraging or cheerful. Such images may be provided by the client or by the client's family or other designated contacts, or may be selected from an image library or other source. Similarly, a background screen on the client's mobile phone could be updated in a comparable way.

Depending on the level of access PRC 101 is afforded to the client's home, other kinds of measures may be applied. For example, the user's home computer, television, or other appliance could be configured to perform special filtering of internet content, so that potentially disturbing news may be withheld or delayed. Other environmental changes that could be made, with appropriate control and communication systems in place, include adjusting the lighting level or temperature in the client's home, or other environmental alterations.

In some embodiments, events or other information received about a client may be assigned a priority or urgency rating, indicating whether a response on the part of PRC 101 should be prioritized over other responses. For example, recognition of an impending weather pattern that may affect a client's mood may be assigned a low priority or urgency rating. However, if a client self-reports to a customer service representative during a weekly check-in call that the client has quit taking a prescribed medication, PRC 101 may prioritize notification of one or more contacts listed in the client's personal profile.

In some embodiments, patterns detected in relation to other clients may be used in predicting the onset of a particular mood on the part of a particular client. For example, a particular client may not have experienced a particular rare traumatic event, and thus historical information relating to that particular client will not reflect any historical reaction to that particular event, and no pattern relating to the event may be discernible for the particular client. However, among the many other clients of PRC 101, such an event may have occurred in the lives of a number of other clients, and it may be presumed that the particular client will react in a manner similar to the reactions exhibited by the other clients to whom the event has occurred. Examples of such rare and potentially traumatic events may include a hospitalization, the loss of a beloved pet, or other similar events.

Thus, in some embodiments, the method may include receiving a variety of historical information about a plurality of other clients of PRC 101, storing that historical information, and detecting patterns in that information, such that the recognition that a new event in a particular client's life may indicate the possible onset of a negative mood can be based at least in part on the patterns detected with respect to the other clients.

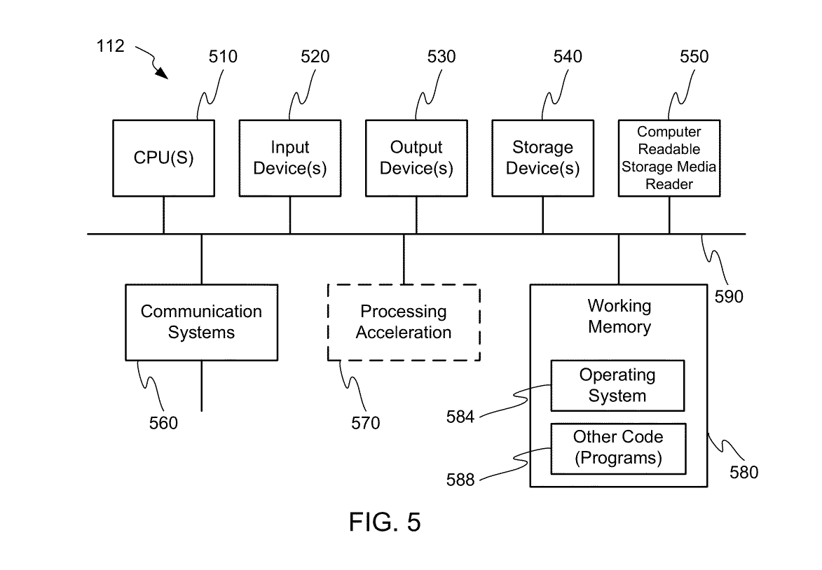

Many of the functions of PRC 101 may be performed by or with the assistance of computer system 112. FIG. 5 illustrates a simplified block diagram of an example embodiment of the internal structure of computer system 112. The computer system 112 is shown comprising hardware elements that may be electrically coupled via a bus 590. The hardware elements may include one or more central processing units 410, one or more input devices 520 (e.g., a keyboard, mouse, or other input device of combination of devices), and one or more output devices 540 (e.g., a display, printer, or other device or combination of devices). The computer system 112 may also include one or more storage device(s) 540. By way of example, storage device(s) 540 may be disk drives, optical storage devices, solid-state storage device such as a random access memory (“RAM”) and/or a read-only memory (“ROM”), which can be programmable, flash-updateable and/or the like.

The computer system 112 may additionally include a computer-readable storage media reader 550, a communications system 560 (e.g., a modem, a network card (wireless or wired), an infra-red communication device, Bluetooth™ device, cellular communication device, etc.), and working memory 580, which may include RAM and ROM devices as described above. In some embodiments, the computer system 112 may also include a processing acceleration unit 570, which can include a digital signal processor, a special-purpose processor and/or the like.

The computer-readable storage media reader 550 can further be connected to a computer-readable storage medium, together (and, optionally, in combination with storage device(s) 540) comprehensively representing remote, local, fixed, and/or removable storage devices plus storage media for temporarily and/or more permanently containing computer-readable information. The communications system 560 may permit data to be exchanged with a network, system, computer and/or other component described above.

The computer system 112 may also comprise software elements, shown as being currently located within a working memory 580, including an operating system 584 and/or other code 588. It should be appreciated that alternate embodiments of a computer system 112 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 112 may include code 588 for implementing any or all of the function of the various elements of the architecture as described herein. For example, software, stored on and/or executed by a computer system such as system 112, can provide some of the functions of private response center 101 such as those discussed above. Methods implementable by software on some of these components have been discussed above in more detail.

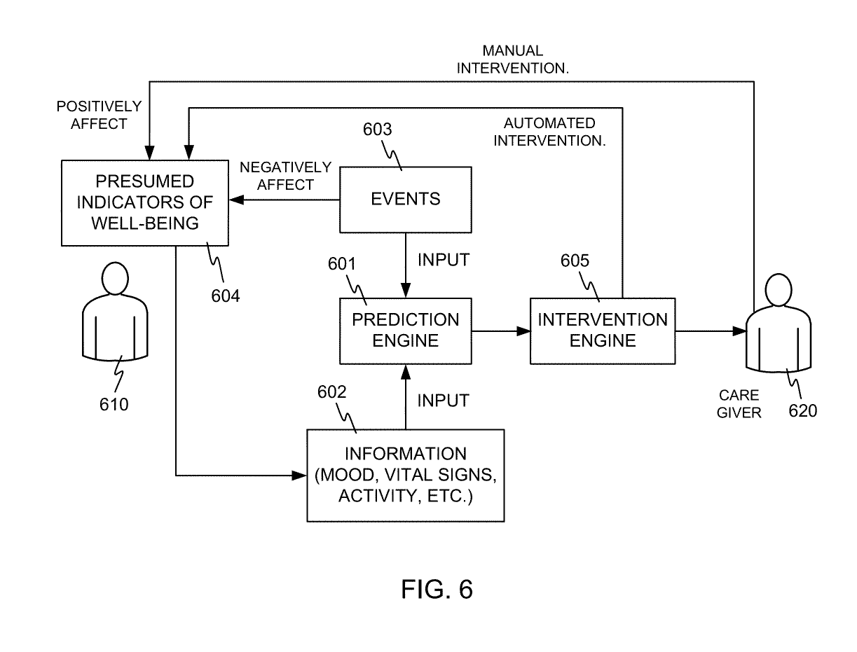

FIG. 6 illustrates a schematic view of the operation of a system in accordance with embodiments. A prediction engine 601 receives inputs of information 602 about an individual or a number of individuals such as individual 610, as well as inputs describing events 603 that occur in the lives of the individuals. As is explained above, the received information may include a wide variety of information, including geographical location, vital signs, environment, self-reported moods, or other information of combinations of information. The received events may include visits away from home, news events, weather patterns, self-reported events, or other events or combinations of events occurring in the lives of the individuals. In some embodiments, some events may be identified based on an analysis of the received information 602. Some of events 603 may negatively affect presumed indicators 604 of the mental or physical well-being of one or more individuals 610. Based on a statistical analysis of the received information and events, prediction engine 601 recognizes the possible onset of a negative mood or other change in the mental or physical well-being of a particular one of the individuals 610. An intervention engine 605 may apply one or more measures presumed to positively affect the mental or physical well-being of the individual. As is explained above, the measures may include notifying one or more persons such as caregiver 620 designated by the individual, sending encouraging messages to the individual, calling the individual to inquire further about his or her health, or other measures or combinations of measures. Some intervention measures may be automated, for example sending encouraging messages via email. Other intervention measures may be performed manually, for example contacting a particular individual 610 by caregiver 620 of by a customer service representative. Combinations of automated and manual measures such as the measures described above may be used. Prediction engine 601 may be implemented entirely or with the assistance of a specially-programmed computer system such as computer system 112.

Information 602 received by prediction engine 601 may be stored in electronic storage, and new information collected on an ongoing basis for use in future pattern recognitions.

While the principles of the disclosure have been described above in connection with specific apparatuses and methods, it is to be clearly understood that this description is made only by way of example and not as limitation on the scope of the disclosure.

1. A method, comprising:
receiving a variety of historical information about a first client of a call center, wherein a client of the call center is a subscriber to and a subject of an assistance service offered by the call center, the historical information indicating that certain prior events have occurred in the life of the first client, wherein the assistance service is offered for the benefit of its subscribed clients;
storing the historical information about the first client in electronic storage;
receiving a variety of historical information about a plurality of other clients of the call center, the historical information indicating that certain prior events have occurred in the lives of the other clients;
storing the historical information about the plurality of other clients in electronic storage;
detecting, using a computer system specially programmed to do so, one or more patterns that correlate the prior events occurring to the first client to presumed indicators of the first client's mental state;
detecting, using the computer system, one or more patterns that correlate the prior events occurring to the other clients to presumed indicators of the other clients' mental states;
recording in the electronic storage a description of the one or more detected patterns relating to the first client and the one or more detected patterns relating to the other clients;
receiving additional information about the first client, indicating that one or more additional events have occurred in the life of the first client;
automatically recognizing, by the computer system, that one or more additional events presumed to indicate the possible onset of an impending negative mental state on the part of the first client have occurred, wherein the recognition is based at least in part on the one or more patterns detected with respect to the other clients; and
applying one or more measures presumed to mitigate the negative mental state on the part of the first client.

2. (canceled)

3. The method of claim 1, wherein the historical information and the additional information include measurements of one or more biological factors of the first client, and wherein a particular measurement or set of measurements of one or more of the one or more biological factors constitutes an event.

4. The method of claim 3, wherein the measurements of one or more biological factors of the first client include measurements of any one, any combination, or all of the factors in the group consisting of a body temperature of the first client, a blood pressure of the first client, a weight of the first client, a heart rate of the first client, and an activity level of the first client.

5. The method of claim 3, wherein measurements of at least one of the one or more biological factors of the first client are made automatically and are received at the call center after transmission over a wireless link.

6. The method of claim 5, wherein at least one biological factor is measured using a device worn by the first client.

7. The method of claim 3, wherein measurements of one or more biological factors of the first client include one or more measurements self-reported by the first client.

8. The method of claim 1, wherein the historical information and the additional information include measurements of one or more environmental factors, and wherein a particular measurement or set of measurements of one or more of the one or more environmental factors constitutes an event.

9. The method of claim 8, wherein the measurements of one or more environmental factors include measurements of any one, any combination, or all of the environmental factors selected from the group consisting of the first client's location, the environmental temperature at the first client's location, the barometric pressure at the first client's location, the pollen count at the first client's location, the humidity at the first client's location, the air quality at the first client's location, and the weather at the first client's location.

10. The method of claim 8, wherein measurements of at least one of the one or more environmental factors are made automatically and are received at the call center after transmission over a wireless link.

11. The method of claim 1, wherein at least one event is self-reported by the first client.

12. The method of claim 1, wherein the prior and additional events comprise any one, any combination, or all of the events selected from the group consisting of a news report of a current event, a report of a particular weather pattern, and emergency alert issued by an official agency, and a forecast of a particular weather pattern.

13. The method of claim 1, wherein at least one mental state is self-reported by the first client.

14. The method of claim 1, wherein the one or more measures presumed to mitigate the negative mental state on the part of the first client include any one, any combination, or all of the measures selected from the group consisting of sending one or more electronic messages to the first client intended to mitigate the negative mental state, notifying a person previously designated by the first client, and altering the first client's environment.

15. The method of claim 1, further comprising storing the additional information in the electronic storage, such that the additional information is historical information in a future analysis.

16. (canceled)

17. A system, comprising:
a processor;
electronic storage; and
a memory, the memory holding instructions that when executed by the processor cause the system to
receive a variety of historical information about a first person who is a subscriber to and a subject of a monitoring service, the historical information indicating that certain prior events have occurred in the life of the first person, wherein the monitoring service is provided for the benefit of its subscribed subjects;
store the historical information in the electronic storage;
receive a variety of historical information about a plurality of other persons who are also subjects of the monitoring service, the historical information indicating that certain prior events have occurred in the lives of the other persons who are subscribers to and subjects of the monitoring service;
store the historical information about the plurality of other persons in electronic storage;
detect one or more patterns that correlate the prior events occurring to the first person to presumed indicators of the first person's mental state;
detect one or more patterns that correlate the prior events occurring to the other persons to resumed indicators of the other persons' mental states;
record in the electronic storage a description of the one or more detected patterns relating to the first person and the one or more detected patterns relating to the other persons;
receive additional information about the first person, indicating that one or more additional events have occurred in the life of the first person;
automatically recognize that one or more additional events presumed to affect the first person's impending mental state have occurred, wherein the recognition is based at least in part on the one or more patterns detected with respect to the other persons; and
apply one or more measures presumed to mitigate the effects of the one or more additional events on the first person's mental state.

18. (canceled)

19. The system of claim 17, further comprising an electronic communication interface, and wherein at least one of the one or more measures presumed to mitigate the effects of the one or more additional events on the first person's mental state is applied through the electronic communication interface.

20. A system for engaging individuals, the system comprising:
a processor;
electronic storage; and
a memory, the memory holding instructions that when executed by the processor cause the system to
receive information about a plurality of individuals who are subscribed to and are subjects of a monitoring service and detect within the received information patterns correlating events occurring in the lives of the individuals with presumed indicators of the individuals' mental or physical well-being, wherein the monitoring service is provided for the benefit of the subscribed subjects of the monitoring service and includes a personalized assistance service provided for the benefit of the subscribed subjects;
predict, based on the recognized patterns and additional received information that includes indications of events occurring in the life of a particular one of the plurality of individuals, an impending change to the particular individual's mental or physical well-being; and
in response to the prediction of the impending change, apply one or more measures presumed to positively affect the particular individual's mental or physical well-being.

21. The system of claim 20, wherein the system identifies at least some events from the received information.

22. The system of claim 20, wherein at least one measure presumed to positively affect the particular individual's mental or physical well-being is applied using human assistance.

23. The system of claim 20, wherein the received information includes measurements of one or more biological factors of the particular one of the plurality of individuals, and wherein a particular measurement or set of measurements of one or more of the one or more biological factors constitutes an event.

24. The system of claim 20, wherein the one or more measures presumed to positively affect the particular individual's mental or physical well-being include any one, any combination, or all of the measures selected from the group consisting of sending one or more electronic messages to the particular individual intended to mitigate the negative mental state, notifying a person previously designated by the particular individual, and altering the particular individual's environment.

25. The system of claim 20, wherein the system detects patterns correlating events occurring in the lives of the individuals based in part on keywords associated with at least some of the events.
